(19) United States
(12) Patent Application Publication
(10) Pub. No.: US 2026/0129738 A1
(43) Pub. Date: May 7, 2026

(54) ELECTRONIC CIRCUIT AND METHOD FOR PROVIDING A HIGH TUBE VOLTAGE FOR AN X-RAY TUBE, METHOD FOR OPERATING AN X-RAY TUBE, X-RAY TUBE SYSTEM AND MEDICAL IMAGING APPARATUS

(71) Applicant: Siemens Healthineers AG, Forchheim (DE)

(72) Inventors: Leopold OTT, Ahorn (DE); Stefan WAFFLER, Buckenhof (DE)

(73) Assignee: Siemens Healthineers AG, Forchheim (DE)

(21) Appl. No.: 19/380,217

(22) Filed: Nov. 5, 2025

(30) Foreign Application Priority Data
Nov. 6, 2024 (EP) 24211204.3

(51) Int. Cl. H05G 1/12

(52) U.S. Cl. CPC H05G 1/12

(57) ABSTRACT

A first inverter unit receives an input DC voltage and converts the input DC voltage into a first AC voltage based on a first manipulated variable. A second inverter unit converts the input DC voltage into a second AC voltage based on a second manipulated variable. A further circuit part generates the high tube voltage based on the first and second AC voltages. A controller determines a controlled variable, and changes the first and/or the second manipulated variable based on the controlled variable. The controlled variable is based on a first alternating current resulting from the first AC voltage and a second alternating current resulting from the second AC voltage, and/or a first direct current resulting from the input DC voltage at the first inverter unit and a second direct current resulting from the input DC voltage at the second inverter unit.

### CROSS-REFERENCE TO RELATED APPLICATION(S)

The present application claims priority under 35 U.S.C. § 119 to European Patent Application No. 24211204.3, filed Nov. 6, 2024, the entire contents of which is incorporated herein by reference.

### FIELD

One or more example embodiments of the present invention relate to an electronic circuit for providing a high tube voltage for an X-ray tube. One or more example embodiments of the present invention also relate to an X-ray tube system with such an electronic circuit and a medical imaging system with such an X-ray tube system. One or more example embodiments of the present invention further relate to corresponding methods.

### BACKGROUND

An X-ray tube is a special type of electron beam tube for generating X-rays. X-ray tubes are used in various imaging methods and offer a wide range of possibilities, including in modern medicine.

The generation of X-rays by an X-ray tube requires free electrons that can be accelerated from a cathode to an anode with the aid of a defined high tube voltage. The electrons released, i.e., charges, per unit of time that flow from the cathode to the anode are referred to as tube current. The high tube voltage can typically range from 25 kV to 600 kV. When the accelerated electrons strike the anode, they release energy, which results in energy and characteristic radiation. Since the incident electrons can be deflected or scattered in all directions, they release different amounts of energy in the form of bremsstrahlung depending on the angle of deflection. This creates a continuous X-ray spectrum.

An overall efficiency of an X-ray tube system, i.e., the radiation yield in relation to the input energy, can be very low. For this reason, it may be necessary to supply the X-ray tube with very high power, for example in the order of magnitude of 100 kW.

X-ray tubes are conventionally supplied with power by a power electronic conversion chain. This, for example, first converts a single-phase or three-phase supply AC voltage into an input DC voltage, which is also referred to as the DC link voltage. In a further step, this DC link voltage is used to generate a high-frequency (for example 30 kHz-300 kHz) AC voltage with adjustable amplitude via a transmission circuit to the X-ray tube. Herein, the transmission circuit can contain a resonant circuit, a high-voltage transformer and high-voltage rectification. The level of the high-frequency AC voltage can, for example, be adjusted by actively regulating the DC link voltage, by phase-shifting at least one bridge arm of an inverter or by varying the frequency of the AC voltage.

The purpose of this transmission circuit is to generate a high-voltage DC voltage between the anode and cathode inside the tube, which accelerates the free electrons from a correspondingly heated emitter, which can also be referred to as a filament, on one side of the cathode, thereby forming the current inside the X-ray tube. This current flow in turn generates high-energy X-rays when it strikes the anode, which can be used for medical imaging.

As X-ray tubes, in particular, for CT and radiography applications, can have maximum beam powers in the range of 100 kW and above, power transmission can, for example, be divided into several stages due to the thermal stress on the components of the inverter stage. This can disadvantageously lead to an asymmetrical current and thus power distribution due to an inevitable tolerance in different stages, for example a tolerance of components in the transmission circuit.

### SUMMARY

It is an object of one or more example embodiments of the present invention to reduce the asymmetry of load distribution in multistage supply circuits for the high tube voltage of an X-ray tube.

At least this object is achieved by the respective subject matter of the independent claims. Advantageous developments and preferred embodiments are the subject matter of the dependent claims, the following description and the figures.

One or more example embodiments of the present invention are based on the idea of ensuring more symmetrical load distribution of the multistage supply circuit via output-side control within the framework of AC voltage generation.

According to one aspect of one or more example embodiments of the present invention, an electronic circuit for providing a high tube voltage for an X-ray tube is presented. The electronic circuit has a first inverter unit which is configured to receive an input DC voltage and convert the input DC voltage depending upon a first manipulated variable into a first AC voltage. Furthermore, the electronic circuit has a second inverter unit which is configured to receive the input DC voltage and to convert the input DC voltage into a second AC voltage depending upon a second manipulated variable. Moreover, the electronic circuit has a further circuit part which is configured to generate the high tube voltage depending upon the first AC voltage and the second AC voltage and to make the high tube voltage available on the output side, i.e. at an output of the circuit part. Furthermore, the electronic circuit has a control arrangement (also referred to a controller) which is configured to determine a controlled variable and to change the first manipulated variable and/or the second manipulated variable depending on the controlled variable in order to control the controlled variable to a predetermined setpoint value. Herein, the control arrangement is configured to determine the controlled variable depending on
i) a first alternating current resulting from the first AC voltage and a second alternating current resulting from the second AC voltage and/or
ii) a first direct current resulting from the input DC voltage at the first inverter unit and a second direct current resulting from the input DC voltage at the second inverter unit.

Herein, the controlled variable does not necessarily have to be determined directly from the first alternating current and the second alternating current and/or the first direct current and the second direct current, but can also be determined from other physical variables that depend on these alternating currents and/or these direct currents.

The electronic circuit can in particular contain at least two output terminals designed to supply the high tube voltage to the X-ray tube. The high tube voltage can in particular be applied between an anode and a cathode of the X-ray tube in order to generate X-rays. The high tube voltage can in particular be direct voltage. In this case, a first output terminal can have a positive electrical potential that can be applied to the anode of the X-ray tube and a second output terminal can have a negative electrical potential that can be applied to the cathode of the X-ray tube.

The first inverter unit can contain a first inverter or consist of a first inverter and the second inverter unit can contain a second inverter or consist of a second inverter. The first manipulated variable of the first inverter unit can in particular be a first duty cycle of the first inverter or another parameter of the first inverter that influences the first AC voltage, in particular its effective value. The second manipulated variable of the second inverter unit can in particular be a second duty cycle of the second inverter or another parameter of the second inverter that influences the second AC voltage, in particular its effective value. The respective inverter can in particular have a full bridge or a half bridge in combination with a voltage divider, for example a capacitive voltage divider, which halves the input DC voltage. The full bridge or the half bridge can, for example, be actuated via a PWM signal.

In particular, a first amplitude of the first AC voltage can depend on the first duty cycle and a second amplitude of the second AC voltage can depend on the second duty cycle. A first switching frequency of the first inverter and a second switching frequency of the second inverter are in particular the same in order to avoid a beat effect between the first inverter and the second inverter.

Here, and in the following, a resulting alternating current can be, in particular according to Ohm's law, an alternating current caused by a load, which arises as soon as a corresponding AC voltage is connected to the load. This in particular applies to the first alternating current, the second alternating current, and all further alternating currents.

Here and in the following, a resulting direct current can be, in particular in accordance with Ohm's law, a direct current caused by a further load that arises as soon as a corresponding direct voltage is connected to the further load. This applies in particular to the first direct current, the second direct current, and all further direct currents.

The control arrangement contains, for example, a measuring facility (also referred to as a measuring device) which is configured to measure both the first alternating current and the second alternating current on the output side of the respective inverter and/or to measure the first direct current and the second direct current on the input side of the respective inverter. For example, the control arrangement contains a current measuring device. Herein, the respective values can be measured independently of one another.

The control arrangement can likewise, for example, contain a circuit for determining a first characteristic value of the first alternating current and a second characteristic value of the second alternating current. The first characteristic value can, for example, correspond to a first effective value, a first rectified value or a first peak value. The second characteristic value can, for example, correspond to a second effective value, a second rectified value or a second peak value.

Here and in the following, the values for a rectified value and/or for a peak value can in each case be ascertained within a switching period.

Likewise, the control arrangement contains, for example, a controller which is configured to determine the controlled variable and to output the first manipulated variable and the second manipulated variable depending on the controlled variable and the predetermined setpoint value. The controlled variable can be composed of the measured values of the first alternating current, the first direct current or the first characteristic value and the second alternating current, the second direct current or the second characteristic value, or can be determined depending upon these, i.e. depending only on the first alternating current or the first direct current and the second alternating current or the second direct current or additionally depending on further variables. The determination of the controlled variable can in particular include forming the difference between the first characteristic value and the second characteristic value.

In the case of difference formation when ascertaining the controlled variable, the predetermined setpoint value can in particular be equal to zero. In this case, the control can also be referred to as zero-value control. The first manipulated variable and/or the second manipulated variable are then changed, for example, as long as the first characteristic value is not equal to the second characteristic value. Herein, a value can in particular be considered equal if it exhibits a tolerance-related deviation under real conditions. The deviation can be in the range of a few percent of the first characteristic value or the second characteristic value, in particular in the range of less than 5%.

Likewise, the controller can exhibit hysteresis behavior within a control process. This should be understood to mean control that depends not only on the current value of the controlled variable, but also on the previous value. This means that the control can behave differently depending on whether the control starts from a higher value and moves toward a lower value or vice versa.

Likewise, it is also possible to control deviating predetermined setpoint values.

In one or more example embodiments of the present invention presented, the control can include a change only in the first manipulated variable and not in the second manipulated variable or a change only in the second manipulated variable and not in the first manipulated variable. This can in particular be necessary or desirable if only an adjustment or change to the first inverter unit or only an adjustment or change to the second inverter unit is to be effected and the other inverter unit is in each case to be operated unchanged. In other embodiments, it can be advantageous to change both manipulated variables within the control system, thereby potentially accelerating a control sequence.

An advantage of one or more example embodiments of the present invention described is that a multistage supply circuit for the high tube voltage can be operated symmetrically without using additional components when combining the voltages. Symmetrical operation can, for example, have advantages in terms of heat distribution and the service life of the electronic circuit.

The respective voltage potentials can be combined by simple nodes, i.e. a direct connection without the risk of uneven loading of a supply train. Such uneven loading is unavoidable in known multistage supply circuits due to component tolerances. The electronic circuit, according to one or more example embodiments of the present invention, in particular actively ascertains the alternating currents or the direct currents and the controlled variable depending on this. The electronic circuit, according to one or more example embodiments of the present invention, is therefore not dependent or is less dependent on previously known or selected component tolerances and the control can adapt to the current situation in each case. Therefore, a further advantage is that components of the electronic circuit can be installed independently of one another within industry-standard component tolerances.

According to at least one embodiment of the electronic circuit, the control arrangement contains a PI controller or a PID controller.

The PI controller or the PID controller is in particular configured to change the first manipulated variable and/or the second manipulated variable depending on the controlled variable.

The PI controller (proportional-integral controller) contains both a proportional component and an integral component. In the case of the proportional component, the relationship between an input variable and an output variable is defined by a step function with fixed gain. The integral component shows a linearly increasing time characteristic between the input and output. The PID controller (proportional-integral-derivative controller) also contains a differential component. A step response is an impulse function with a theoretically infinite magnitude.

According to at least one embodiment of the electronic circuit, the controlled variable depends on a difference between the first alternating current and the second alternating current or a difference between the first direct current and the second direct current.

In other words, a value of the first alternating current or the first direct current is subtracted from a value of the second alternating current or the second direct current or vice versa. In the case of alternating currents, this can, for example, be a characteristic value of the first alternating current or a characteristic value of the second alternating current. Likewise, herein, it can be possible that the first alternating current or the first direct current first passes through a first filter unit and the second alternating current or the second direct current first passes through a second filter unit. The difference between the two output values of the two filter units can then be formed. In particular, both the first filter unit and the second filter unit can in each case have an RMS filter (root mean square filter).

For example, if the first alternating current or the first direct current is a minuend and the second alternating current or the second direct current is a subtrahend, the first manipulated variable can be changed downward, i.e., toward a smaller value, and the second manipulated variable can be changed upward, i.e., toward a higher value. In particular, it is also possible for the controlled variable to be dependent on an amount of the difference between the first alternating current or the first direct current and the second alternating current or the second direct current. Likewise, it is possible for the controlled variable to be dependent on a predefined multiple or a predefined fraction of the difference between the first alternating current or the first direct current and the second alternating current or the second direct current.

In the embodiments shown, the controlled variable depends on the difference between alternating currents or the difference between the direct currents that are decisive for the loading on the respective supply train. In particular, the predetermined setpoint value can be zero, so that the control can aim to match the alternating currents or the direct currents to one another. Such a control can likewise be referred to as zero-value control.

One advantage of this embodiment is the simple design and the possibility of control to a zero value, i.e., adjustment of the alternating currents or the two direct currents to the same value, in particular to the same effective value of the two alternating currents.

According to at least one further embodiment of the electronic circuit, the control arrangement is configured to determine a first characteristic value from the first alternating current and to determine a second characteristic value from the second alternating current. Furthermore, the controlled variable depends on the first characteristic value and the second characteristic value or the controlled variable depends on a difference between the first characteristic value and the second characteristic value. The first characteristic value corresponds to a first effective value, a first rectified value or a first peak value and the second characteristic value corresponds to a second effective value, a second rectified value or a second peak value.

Herein, it can be possible that the first alternating current first passes through the first filter unit and the second alternating current first passes through the second filter unit. The difference between the two output values of the two filter units can then be formed. In particular, both the first filter unit and the second filter unit can in each case have an RMS filter (root mean square filter).

For example, if the first characteristic value is the minuend is and the second characteristic value is the subtrahend, the first manipulated variable can be changed downward, i.e., toward a smaller value, and the second manipulated variable can be changed upward, i.e., toward a higher value. In particular it is also possible for the controlled variable to be dependent on an amount of the difference between the first characteristic value and the second characteristic value.

In the embodiments shown, the controlled variable depends on the difference between the characteristic values that are decisive for the loading of the respective supply chain. In particular, the predetermined setpoint value can be zero, so that the control can aim to match the characteristic values to one another. Such a control can likewise be referred to as zero-value control.

One advantage of this embodiment is the simple design and easy further processing of the characteristic values within the control system. Various operations can be performed with the present characteristic values, in particular a difference in the case of two supply trains.

According to at least one further embodiment of the electronic circuit, the control arrangement is configured to ascertain a largest characteristic value, i.e. a maximum of the first characteristic value and the second characteristic value depending upon the first characteristic value and the second characteristic value. Furthermore, the control arrangement is configured to change the first manipulated variable depending on the controlled variable when the first characteristic value is less than the largest characteristic value and to change the second manipulated variable depending on the controlled variable when the second characteristic value is less than the largest characteristic value.

The characteristic value of an alternating current can be understood as a value of a comparable direct current that generates the same heat in an ohmic resistor, for example an effective value of the alternating current. The effective value can be measured with an effective-value-forming current measuring device. To ascertain the largest characteristic value, the first characteristic value can be compared with the second characteristic value and the largest characteristic value can correspond to the larger value of the two.

Here and in the following, in particular the value of the direct current can also be assumed as the characteristic value of a direct current. In particular, the control arrangement can also be embodied to determine the first characteristic value depending upon the first direct current and to determine the second characteristic value depending upon the second direct current.

In other words, in the embodiment, the corresponding manipulated variable of the inverter unit that provides the largest characteristic value can remain unchanged. This allows the inverter of this inverter unit to supply an unchanged AC voltage. Furthermore, the corresponding manipulated variable of the other inverter unit can in each case be adjusted so that the AC voltage supplied by the inverter of this inverter unit can change.

In particular is can be desirable to initially set the manipulated variable, which can also be implemented as the duty cycle of the first or second inverter unit, to the lowest possible value. If the characteristic value of the first or second inverter unit is lower than the largest characteristic value, the manipulated variable of this inverter unit can then, for example, only be adjusted upward, i.e., toward higher values, since downward adjustment, i.e., toward lower values, is no longer possible on the system side.

One advantage of this embodiment is the simple design and the stability of the alternating current supplied by the inverter unit that supplies the higher alternating current or is supplied with the higher direct current. This inverter unit is not adjusted and this can contribute to stabilization of the high tube voltage.

According to at least one further embodiment of the electronic circuit, the control arrangement is configured to ascertain a controller manipulated variable depending upon the controlled variable and the predetermined setpoint value. Furthermore, the first manipulated variable depends on a difference between a predetermined initial value and the controller manipulated variable and/or the second manipulated variable depends on a sum of the predetermined initial value and the controller manipulated variable.

In other words, both the first inverter unit and the second inverter unit can be initialized with the predetermined initial value. This means that, if the respective manipulated variable is a duty cycle, the inverters of the respective inverter units can be initialized with the same duty cycle. The predetermined initial value can be the result of an upstream calculation process that, for example, depends on previous simulations or measurements.

The controller manipulated variable can then be ascertained within the control process. The controller manipulated variable can be an output signal of the controller and depend on the controlled variable and the predetermined setpoint value. The controller manipulated variable can be subtracted from the first manipulated variable, i.e., the first inverter can receive a lower signal. Likewise, the controller manipulated variable can be added to the second manipulated variable, i.e., the second inverter can receive a higher signal. Likewise, this procedure can also be extended to a larger number of inverter units.

Likewise, the control arrangement can contain a PI controller or a PID controller. The PI controller or the PID controller can in particular be configured to change the controller manipulated variable depending on the controlled variable.

One advantage of this embodiment is the uniform initialization of the inverter units and thus faster control to a desired value of the high tube voltage.

According to at least one further embodiment, the further circuit part contains a voltage transformer which is configured to receive, on the primary side, a primary alternating voltage resulting from the first AC voltage and/or the second AC voltage and to convert the primary alternating voltage into a secondary alternating voltage. Furthermore, the high tube voltage is dependent upon the secondary alternating voltage.

In particular, if the further circuit part contains exactly one voltage transformer, a coupling of the first AC voltage and the second AC voltage with, for example, two terminals is required on the primary side of the voltage transformer. This coupling can, for example, be implemented by two direct conductive Connections, i.e., two nodes. In particular, if the further circuit part contains the above-described first resonant circuit and/or the second resonant circuit, the AC voltage provided on the output side of the respective resonant circuit can be forced to an identical voltage potential, namely the voltage potential of the primary alternating voltage, at the node and applied to the primary side of the voltage transformer. Herein, due to the transmission ratio, the voltage transformer can likewise output a higher voltage amplitude, in particular a significantly higher voltage amplitude, on the secondary side than it receives on the primary side.

Likewise, it is possible that the further circuit part contains a further voltage transformer. In this case, the first AC voltage can, for example, be applied to the primary side of the voltage transformer, either directly or via the first resonant circuit. Likewise, the second AC voltage can be applied either directly or via the second resonant circuit to the further voltage transformer. The respective secondary alternating voltage can then, for example, be connected to one another by two further nodes.

One advantage of this embodiment is the galvanic isolation and the increase in voltage amplitude by the voltage transformer.

According to a further embodiment, the further circuit part contains a rectifier, in particular exactly one rectifier which is configured to convert the secondary alternating voltage into the high tube voltage.

The rectifier can, for example, supply the high tube voltage at two terminal points of the X-ray tube. The two terminal points of the rectifier can in particular be identical to the output terminals of the electronic circuit.

Likewise, the rectifier can receive an alternative AC voltage that depends on the first AC voltage and the second AC voltage, in particular by connecting the two alternating voltages by a node. The rectifier can likewise convert the alternative AC voltage into the high tube voltage and supply this to the X-ray tube.

Likewise, the further circuit part can contain a further rectifier. In this case, the respective high tube voltage on the output side can be coupled to one another with an additional node.

A node at which voltages are coupled to one another can be understood here and in the following as meaning that there is a conductive connection with a low ohmic resistance, in particular an ohmic resistance of zero, at this point, and as a result the electrical potential is forced to an identical value at the node during operation.

One advantage of this embodiment is that the rectifier supplies the high tube voltage in a form that can be used in the X-ray tube to generate X-rays.

According to a further embodiment, the further circuit part contains a first resonant circuit which is coupled on the input side, i.e. at an input of the resonant circuit, to an output of the first inverter unit and on the output side, i.e. at an output of the resonant circuit, to an output of the further circuit part which is configured to provide the high tube voltage. Furthermore, the further circuit part contains a second resonant circuit which is coupled on the input side to an output of the second inverter unit and on the output side to the output of the further circuit part which is configured to provide the high tube voltage.

The first resonant circuit and the second resonant circuit can, for example, in each case be constructed from a series circuit consisting of a capacitance and an inductance. Likewise, further components can be contained in series and/or in parallel in the first resonant circuit and the second resonant circuit.

One advantage of this embodiment is the possible compensation of parasitic elements of the remaining electronic circuit and thus a lower reactive power, which can occur due to a build-up or degradation of electrical and magnetic fields in capacitive or inductive elements.

According to a further embodiment, an output of the first resonant circuit is coupled to an output of the second resonant circuit.

In particular, an output of the first resonant circuit consisting of two terminal connections and an output of the second resonant circuit consisting of two further terminal connections can be connected to one another, i.e., for example short-circuited. This allows the two resonant circuits to be connected to an input of the voltage transformer, for example.

Alternatively, one embodiment can also contain the further voltage transformer. The output of the first resonant circuit can then be connected to the voltage transformer and the output of the second resonant circuit can be connected to the further voltage transformer.

One advantage of this embodiment is a power combination of the supply lines contained therein and thus an increase in the total power available to the X-ray tube. The first and second resonant circuit can be configured accordingly in order to optimize a voltage curve and a current curve.

According to a further embodiment, the electronic circuit contains at least one further inverter unit, wherein each of the at least one further inverter units is configured to receive the input DC voltage and to convert the input DC voltage into a respective further AC voltage depending upon a respective further manipulated variable. Furthermore, the further circuit part is configured to generate the High tube voltage depending upon the further alternating voltages, i.e. in particular depending upon all further alternating voltages generated via the at least one further inverter unit. Moreover, the control arrangement is configured to determine the controlled variable depending upon
i) the first alternating current, the second alternating current and a respective further alternating current resulting from the further alternating voltages and/or
ii) the first direct current, the second direct current and a respective further direct current resulting from the input DC voltage at each further inverter unit of the at least one further inverter unit.

In some embodiments, the control arrangement is configured to change the respective further manipulated variable depending on the controlled variable in order to control the controlled variable to the predetermined setpoint value.

In particular, the above-described embodiments can likewise be extended by the at least one further inverter unit. By way of example, an embodiment with three inverter units is presented, i.e., the at least one further inverter unit is exactly one further inverter unit. Each of the three inverter units, i.e. the first, the second and the further inverter unit can receive the input voltage on the input side. Likewise, each of the three inverter units can operate in dependence on an individual manipulated variable: the first inverter unit on the first manipulated variable, the second inverter unit on the second manipulated variable and the further inverter unit on a further manipulated variable. The further circuit part can be configured to generate the high tube voltage depending upon the first AC voltage, the second AC voltage and the further AC voltage. Each of the three inverter units described in this example can generate an alternating current resulting from the respective AC voltage: the first inverter unit the first alternating current, the second inverter unit the second alternating current and the further inverter unit a further alternating current. Likewise, each of the three inverter units can generate a direct current resulting from the input DC voltage: the first inverter unit the first direct current, the second inverter unit the second direct current and the further inverter unit a further direct current. The control arrangement can be configured to determine the controlled variable from the first alternating current, the second alternating current and the further alternating current or from the first direct current, the second direct current and the further direct current. The control arrangement can change the first manipulated variable and/or the second manipulated variable and/or the further manipulated variable depending upon the controlled variable. Therefore, all three manipulated variables can be changed, i.e., all three inverter units can be influenced, or two of the three inverter units or only one of the three inverter units.

In particular, the control arrangement can also be configured to first ascertain the inverter unit that supplies the largest alternating current or the largest direct current. This inverter unit can, for example, remain unchanged in the control process. A difference between the two smaller alternating currents or direct currents of the other two inverter units can then be ascertained in each case. The controlled variable can then be dependent upon this difference or equal to this difference. The two manipulated variables of the two inverter units can then be changed depending upon the controlled variable.

The described example can also be extended to a plurality of further inverter units, wherein an alternating current resulting from the respective AC voltage specific to the respective inverter unit or a direct current resulting from the input DC voltage specific to the respective inverter unit can always be incorporated into the controlled variable as a dependent variable and thus change the control process. In particular, the controlled variable can depend on all resulting alternating currents and/or all direct currents from the inverter units.

One advantage of the described embodiment is the scalability of the presented invention. Depending on the power requirement, a further power stage can be added and the control process extended accordingly.

According to a further aspect of one or more example embodiments of the present invention, an X-ray tube system, in particular an X-ray tube system for a medical imaging system, is disclosed having the electronic circuit according to one or more example embodiments of the present invention and the X-ray tube.

Herein, the X-ray tube can contain a cathode and an anode for generating an X-ray current, which can be supplied with a high tube voltage by the electronic circuit. In particular, the electronic circuit is connected to the cathode and the anode in such a way that a positive voltage component of the tube voltage can be applied to the anode and a negative voltage component of the tube voltage can be applied to the cathode. In addition to the electronic circuit and the X-ray tube, the X-ray tube system can contain further components, such as, for example, a housing.

Further embodiments of the X-ray tube system according to one or more example embodiments of the present invention follow directly from the different embodiments of the electronic circuit according to the present invention. In particular, individual features and corresponding explanations and advantages relating to the different embodiments of the apparatuses according to the present invention can be transferred analogously to corresponding embodiments of the X-ray tube system according to the present invention.

According to a further aspect of one or more example embodiments of the present invention, a medical imaging system having an X-ray tube system according to one or more example embodiments of the present invention is disclosed.

The medical imaging system can, for example, be an X-ray system, in particular a digital X-ray system, both a stationary and a mobile system, or a specialized X-ray device, such as a computed tomography system (CT system), a cone beam CT system, a mammography system, a dental X-ray system, a fluoroscopy system, an angiography system, a C-arm system or even a conventional X-ray device.

Further embodiments of the medical imaging system according to the present invention follow directly from the different embodiments of the X-ray tube system according to the present invention or the electronic circuit according to one or more example embodiments of the present invention. In particular, individual features and corresponding explanations and advantages relating to the different embodiments of the apparatuses according to the present invention can be transferred analogously to corresponding embodiments of the medical imaging system according to the present invention.

According to a further aspect of one or more example embodiments of the present invention, a method for providing a high tube voltage of an X-ray tube is presented. Herein, an input DC voltage is converted into a first AC voltage depending upon a first manipulated variable and the input DC voltage is converted into a second AC voltage depending upon a second manipulated variable. Furthermore, the high tube voltage is generated depending upon the first AC voltage and the second AC voltage and the high tube voltage is made available. In addition, a controlled variable is determined depending upon
i) a first alternating current resulting from the first AC voltage and a second alternating current resulting from the second AC voltage and/or
ii) a first direct current resulting from the input DC voltage at the first inverter unit and a second direct current resulting from the input DC voltage at the second inverter unit.

In addition, the first manipulated variable and/or the second manipulated variable is changed depending upon the controlled variable in order to control the controlled variable to a predetermined setpoint value.

According to at least one embodiment of the method, the controlled variable depends on a difference between the first alternating current and the second alternating current or on a difference between the first direct current and the second direct current or the controlled variable depends upon a difference between a first characteristic value of the first alternating current and a second characteristic value of the second alternating current. The first characteristic value corresponds to a first effective value, a first rectified value or a first peak value and the second characteristic value corresponds to a second effective value, a second rectified value or a second peak value.

Further embodiments of the method according to the present invention follow directly from the different embodiments of the electronic circuit according to the present invention and vice versa. In particular, individual features and corresponding explanations and advantages relating to the different embodiments of the electronic circuit according to the present invention can be transferred analogously to corresponding embodiments of the method according to the present invention. In particular, the electronic circuit according to one or more example embodiments of the present invention is embodied or programmed to perform a method according to one or more example embodiments of the present invention. In particular, the electronic circuit according to one or more example embodiments of the present invention is embodied or programmed to perform the method according to one or more example embodiments of the present invention. In particular, the electronic circuit according to one or more example embodiments of the present invention performs the method according to one or more example embodiments of the present invention.

According to a further aspect of one or more example embodiments of the present invention, a method for operating an X-ray tube is presented, wherein one of the presented methods is performed to provide a high tube voltage of an X-ray tube and generated by the X-ray tube depending upon the high tube voltage X-rays.

Further embodiments of the method according to the present invention follow directly from the different embodiments of the electronic circuit according to the present invention and vice versa. In particular individual features and corresponding explanations and advantages relating to the different embodiments of the electronic circuit according to the present invention can be transferred analogously to corresponding embodiments of the method according to the present invention. In particular, the electronic circuit according to one or more example embodiments of the present invention is embodied or programmed to perform a method according to one or more example embodiments of the present invention. In particular, the electronic circuit according to one or more example embodiments of the present invention performs the method according to one or more example embodiments of the present invention.

Further features and feature combinations of the present invention will become apparent from the figures and their description and from the claims. In particular, further embodiments of the present invention not do not necessarily have to contain all the features of one of the claims. Further embodiments of the present invention can have features or feature combinations that are not mentioned in the claims.

### BRIEF DESCRIPTION OF THE DRAWINGS

The present invention is explained in more detail below with reference to specific exemplary embodiments and associated schematic drawings. In the figures, identical or functionally identical elements can be given the same reference symbols. The description of identical or functionally identical elements may not necessarily be repeated for different figures.

In the figures:

FIG. 1 shows a schematic block diagram of an exemplary embodiment of an electronic circuit according to the present invention; and

FIG. 2 shows a schematic block diagram of a further exemplary embodiment of an electronic circuit according to the present invention; and

FIG. 3 shows a schematic block diagram of part of a control arrangement of a further exemplary embodiment of an electronic circuit according to the present invention; and

FIG. 4 shows a schematic block diagram of a further part of a control arrangement of a further exemplary embodiment of an electronic circuit according to the present invention; and

FIG. 5 shows a schematic block diagram of a further part of a control arrangement of a further exemplary embodiment of an electronic circuit according to the present invention.

### DETAILED DESCRIPTION

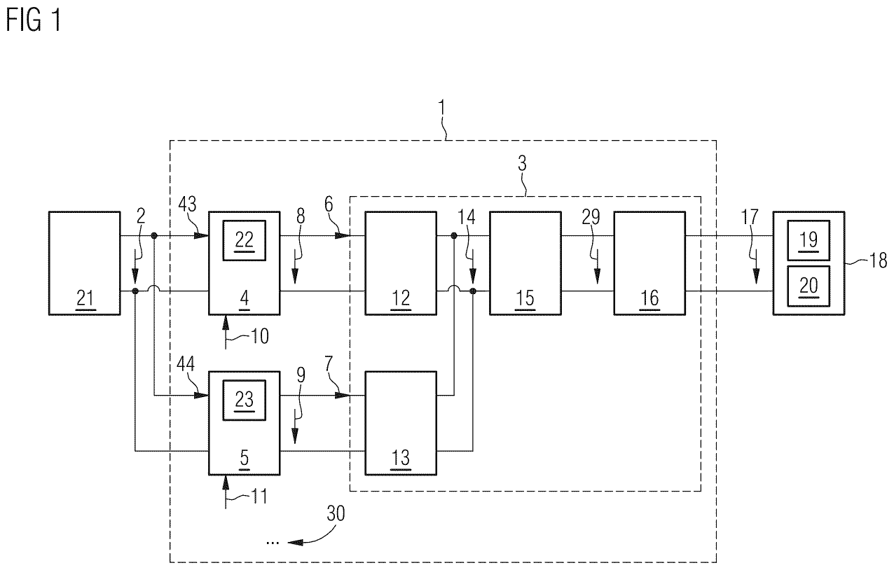

FIG. 1 shows an exemplary embodiment of an electronic circuit 1 according to the present invention for providing a high tube voltage 17 for an X-ray tube 18. The electronic circuit 1 has a first inverter unit 4 which is configured to receive an input DC voltage 2 and to convert the input DC voltage 2 into a first AC voltage 8 depending upon a first manipulated variable 10. Furthermore, the electronic circuit 1 has a second inverter unit 5 which is configured to receive the input DC voltage 2 and to convert the input DC voltage 2 into a second AC voltage 9 depending upon a second manipulated variable 11. Likewise, the electronic circuit 1 has a further circuit part 3 which is configured to generate the high tube voltage 17 depending upon the first AC voltage 8 and the second AC voltage 9 and to make the high tube voltage 17 available on the output side. The electronic circuit 1 also has a control arrangement 24 which is configured to determine a controlled variable 25 and to change the first manipulated variable 10 and/or the second manipulated variable 11 depending upon the controlled variable 25 in order to control the controlled variable 25 to a predetermined setpoint value 26. The control arrangement 24 is configured to determine the controlled variable 25 depending upon
i) a first alternating current 6 resulting from the first AC voltage 8 and a second alternating current 7 resulting from the second AC voltage 9 and/or
ii) a first direct current 43 resulting from the input DC voltage 2 at the first inverter unit 4 and a second direct current 44 resulting from the input DC voltage 2 at the second inverter unit 5.

FIG. 1 likewise shows schematically the X-ray tube 18, which contains an anode 19 and a cathode 20. The High tube voltage 17 is provided by the electronic circuit 1 on the output side and can be coupled to the anode with a positive electrical potential 19 and to the cathode 20 with a negative electrical potential to generate X-rays. Herein, coupling can in particular be established by an electrically conductive connection. FIG. 1 also shows a DC voltage source 21 which can supply the input DC voltage 2, in particular to the electronic circuit 1.

The X-ray tube 18 is not part of the electronic circuit 1 according to one or more example embodiments of the present invention. However, the electronic circuit 1 according to one or more example embodiments of the present invention and the X-ray tube 18 form, for example, an X-ray tube system according to one or more example embodiments of the present invention. The X-ray tube system is in particular part of an X-ray based medical imaging system or is intended for an X-ray-based medical imaging system. The DC voltage source 21 is not necessarily part of the electronic circuit 1 according to one or more example embodiments of the present invention. However, in some embodiments, the DC voltage source 21 can be part of the electronic circuit 1 according to the present invention or of the X-ray tube system according to the present invention.

The first inverter unit 4 can contain a first inverter 22. Likewise, the second inverter unit 5 can contain a second inverter 23. Herein, both the first inverter 22 and the second inverter 23 can, for example, be embodied as PWM inverters. The first inverter 22 can in particular provide the first AC voltage 8 on the output side, which is dependent on the first manipulated variable 10. Herein, the first manipulated variable 10 can, for example, correspond to a first duty cycle of the first inverter 22. The second inverter 23 can in particular provide the second AC voltage 8 on the output side; this is dependent on the second manipulated variable 10. Herein, the second manipulated variable 10 can, for example, correspond to a second duty cycle of the second inverter 22.

Both the first inverter unit 4, and the inverter unit 5 can receive the input DC voltage 2 on the input side. The input DC voltage 2 can be provided by a DC voltage source 21.

The further circuit part 3 is depicted by way of example in FIG. 1 with a first resonant circuit 12, a second resonant circuit 13, a voltage transformer 15 and a rectifier 16. In addition, the further circuit part 3 can have a first and a second node. The first and second nodes represent, for example, an electrically conductive connection and can in each case couple an output of the first resonant circuit 12 to an output of the second resonant circuit 13 in each case. A primary alternating voltage 14 can be applied between the first node and the second node. This primary alternating voltage 14 can in particular be regarded as a superposition or combination of an output voltage of the first resonant circuit 12 and an output voltage of the second resonant circuit 13. The voltage transformer 15 can convert the primary alternating voltage 14 into a secondary alternating voltage 29 depending upon a transmission ratio and make this available on the output side. The rectifier 16 can receive this secondary alternating voltage 29 on the input side and convert it into the high tube voltage 17, which can be made available to the X-ray tube 18.

In particular, different circuits of the further circuit part 3 are also conceivable, for example including a further voltage transformer. In this case, the output of the first resonant circuit 12 can be connected to the voltage transformer 15 and the output of the second resonant circuit 13 can be connected to the further voltage transformer. In addition, the further circuit part 3 can have a third and a fourth node. The third node can connect a first output of the voltage transformer 15 to a first output of the further transformer and the fourth node can connect a second output of the voltage transformer 15 to a second output of the further transformer. A further secondary alternating voltage can then be applied between the third and fourth nodes.

Likewise, the further circuit part 3 can contain a further rectifier. In this case, an output of the further transformer can be connected to an input of a further rectifier. A fifth node can connect a first output of the rectifier 16 to a first output of a further rectifier and a sixth node can connect a second output of the rectifier 16 to a second output of a further rectifier. The high tube voltage 17 can then be applied between the fifth and the sixth nodes.

The first AC voltage 8 applied to an output of the first inverter unit 4 can cause the first alternating current 6, in particular due to the wiring circuit present, in particular a wiring circuit through the further circuit part 3. Likewise, the second AC voltage 9 applied at an output of the second inverter unit 5 can cause the second alternating current 7, in particular due to a wiring circuit present there, in particular the wiring circuit through the further circuit part 3.

The input DC voltage 2applied to an input of the first inverter unit 4 can cause the first direct current 43 at the first inverter unit 4. Likewise, the input DC voltage 2 applied to an input of the second inverter unit 5 can cause the second direct current 44 at the second inverter unit 5.

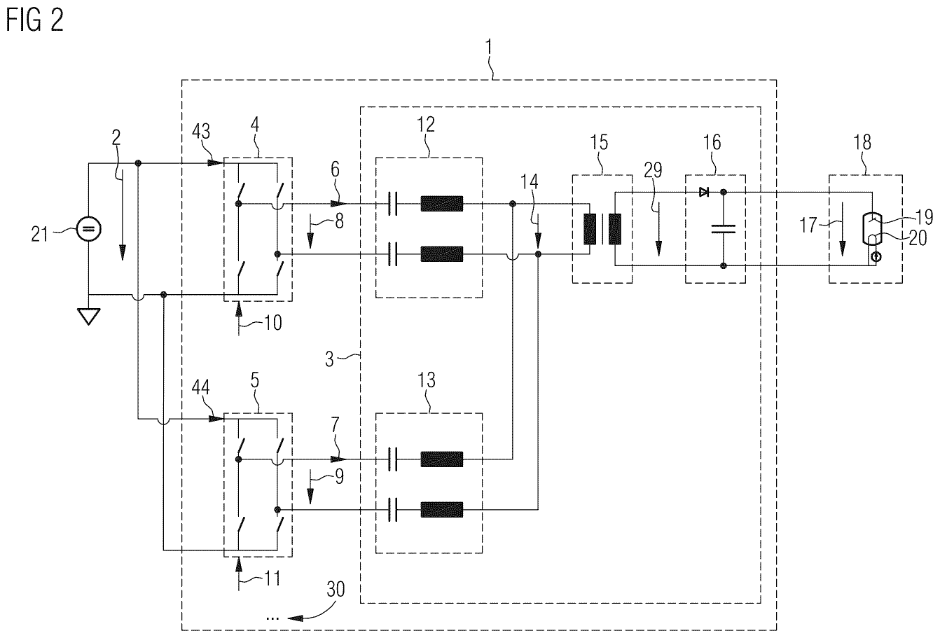

A further exemplary embodiment of the electronic circuit 1 is shown in the block diagram in FIG. 2. The exemplary embodiment shown in FIG. 2 can analogously have all the features of an embodiment with reference to FIG. 1 and/or shown in FIG. 1, unless shown or mentioned otherwise.

FIG. 2 shows by way of example a ground potential at an output of the DC voltage source 21. In particular, a further output of the DC voltage source 21 can have an electrically positive potential. The input DC voltage 2 can be applied between the output of the DC voltage source 21 and the further output of the DC voltage source 21.

The first inverter unit 4 is depicted in FIG. 2 with four switches by way of example. This embodiment can also be referred to as a full bridge. The four switches can be actuated by way of example by four control lines T1_CH1, T2_CH1, T3_CH1, T4_CH1 of a first control signal generator 38. An example of how the first control signal generator 38 can be realized is depicted in FIG. 5. Herein, in each case, a control line T1_CH1, T2_CH1, T3_CH1, T4_CH1 can correspond to an actuator for a switch. For example, a first control line T1_CH1 can actuate a first switch, a second control line T2_CH1 can actuate a second switch, and so on.

Likewise, the second inverter unit 5 is depicted in FIG. 2 by way of example with four further switches. This embodiment can also be referred to as a full bridge. The four further switches can by way of example be actuated by four further control lines T1_CH2, T2_CH2, T3_CH2, T4_CH2 of a second control signal generator 39. An example of how the second control signal generator 39 can be realized is likewise depicted in FIG. 5. Herein, in each case a further control line T1_CH2, T2_CH2, T3_CH2, T4_CH2 can correspond to a further actuator for a further switch. For example, a first further control line T1_CH2 can actuate a first further switch, a second further control line T2_CH2 can actuate a second further switch, and so on.

The first control signal generator 38 and the second control signal generator 39 can likewise be referred to as pulse machines.

The first resonant circuit 12 can, for example, have a series circuit of a capacitor and a coil in a first signal path and a further series circuit of a further capacitor and a further coil in a second signal path. The second resonant circuit 13 can, for example, be constructed analogously. Alternatively, the first resonant circuit 12 can differ from the second resonant circuit 13, in particular with regard to the type, size, tolerance or wiring circuit of components.

In the embodiment in FIG. 2, the rectifier 16 is shown by way of example as having a diode and a capacitor. Likewise, further components are conceivable or even advantageous.

The embodiments of the electronic circuit 1 depicted in FIG. 1 and FIG. 2 can likewise be expanded, for example by at least one further inverter unit 30 (depicted in FIG. 1 and FIG. 2 by three dots). The properties of the first inverter unit 4 and the second inverter unit 5 already depicted can likewise apply to the at least one further inverter unit 30. In particular, the input DC voltage 2 can be connected to an input of the at least one further inverter unit 30. Each of the at least one further inverter unit 30 can in each case be dependent one at least one further manipulated variable 33. Herein, each of the at least one further manipulated variable can differ from each of the at other least one further manipulated variable.

Moreover, the further circuit part 3 can contain at least one further resonant circuit connected, for example, to an output of the at least one further inverter unit 30. The at least one further resonant circuit can have analogous properties of the first resonant circuit or the second resonant circuit. A first output of the at least one further resonant circuit can likewise be connected to the first node, and a second output of the at least one further resonant circuit can be connected to the second node. In these two nodes, the power of all of inverter units and resonant circuits connected there can, for example, be combined and guided from there via subsequent components to the X-ray tube 18.

Each of the at least one further inverter unit 30 can have at least one further AC voltage on the output side in each case. This at least one further AC voltage can generate at least one further alternating current due to at least one wiring circuit connected thereto. In addition to the first alternating current 6 and the second alternating current 7, the controlled variable 25 can also be dependent on each individual one of the at least one further alternating current.

Each of the at least one further inverter unit 30 can have at least one further direct current on the input side in each case—this can result from the applied input DC voltage. In addition to the first direct current 43 and the second direct current 44, the controlled variable 25 can also depend on each individual one of the at least one further direct current.

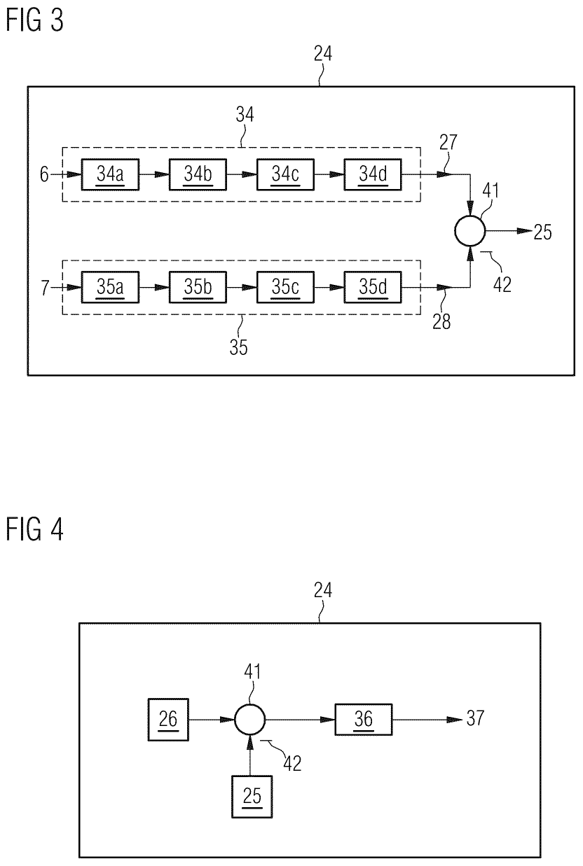

FIG. 3 shows by way of example part of a control arrangement 24 of a further exemplary embodiment of an electronic circuit 1 according to the present invention. Herein, the first alternating current 6 can initially be connected to a first filter unit 34. The first filter unit 34 can, for example, contain a first analog-digital converter 34a, which can create a first digital signal from the analog first alternating current 6. The first digital signal can then be squared in a filter component 34b. The first filter unit 34 can then, for example, contain a low-pass filter 34c. Finally, a square root can be extracted from an output signal of the low-pass filter 34c within a further filter component 34d. An output signal of the first filter unit 34 can, for example, be a first characteristic value 27. In particular, the first filter unit 34 can have an RMS filter (root mean square filter) in the form depicted or in a different form.

The same applies to the second filter unit 35. On the output side, the second filter unit 35 can provide a second characteristic value 28. Moreover, the control arrangement 24 can contain an inverter 42 and an adder 41. For example, the adder 41 can be used to add the first characteristic value 27 to the inverted second characteristic value 28. On the output side, the adder 41 can provide the controlled variable 25.

The first characteristic value can correspond to a first effective value, a first rectified value or a first peak value and the second characteristic value can correspond to a second effective value, a second rectified value or a second peak value. Herein, the values for a rectified value and/or a peak value can in each case be ascertained within a switching period.

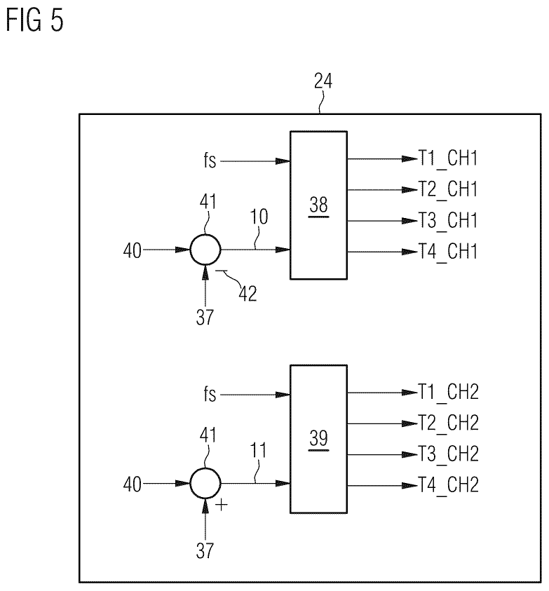

FIG. 4 is a schematic view of a further part of a control arrangement 24 of a further exemplary embodiment of an electronic circuit according to the present invention. For example, the part shown in FIG. 4 can be combined with the part shown in FIG. 3. In particular these can be parts of the same control arrangement 24.

The predetermined setpoint value 26 can be connected to an input of a further adder 41. The controlled variable 25 can initially be connected to a further inverter 42. An output signal inverter 42 can be connected to a further input adder 41. An output of a further adder 41 can be connected to a controller 36. The controller 36 can in particular contain a PI controller or a PID controller. A controller manipulated variable 37 can be provided at an output of the controller 36.

FIG. 5 is a schematic view of a further part of a control arrangement 24 of a further exemplary embodiment of an electronic circuit according to the present invention. For example, the part shown in FIG. 5 can be combined with the part shown in FIG. 3 and/or the part shown in FIG. 4. These can in particular be parts of the same control arrangement 24.

A predetermined initial value 40 can be connected to a first input of a first other adder 41. The controller manipulated variable 37 can be connected to an input of another inverter 42 and an output of the other inverter 42 to a further input of the first other adder 41. The first other adder can be provided at an output of the first manipulated variable. This embodiment likewise shows the first control signal generator 38 which can receive the first manipulated variable 10 at an input and a switching frequency fs at a further input. The switching frequency fs can in particular be selected to be the same for all inverter units 4, 5, 30 in order to avoid loop current. As described above, the first control signal generator 38 can by way of example provide the four control lines T1_CH1, T2_CH1, T3_CH1, T4_CH1 that can actuate the four switches of the first inverter unit 4.

Likewise, FIG. 5 shows the second control signal generator 39. The predetermined initial value 40 can be connected to a first input of a second other adder 41 and the controller manipulated variable 37 can be connected to a further input of the second other adder 41. In contrast to the first control signal generator 38, in this case there is no inverter stage. Likewise, an embodiment with a reversed configuration can be advantageous, i.e. an inverter stage at the second control signal generator 39 and no inverter stage at the first control signal generator 38. The second other adder can be provided at an output of the second manipulated variable. The second control signal generator 39 can receive the second manipulated variable 11 at one input and the switching frequency fs at a further input. The second control signal generator 39 can, as described above, by way of example provide the four further control lines T1_CH2, T2_CH2, T3_CH2, T4_CH2 that can actuate four further switches of the second inverter unit 5.

The control arrangement 24 can likewise contain circuits of the same type that enable actuation of the at least one a further inverter unit 30.

Independent of the grammatical term usage, individuals with male, female or other gender identities are included within the term.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,“ ”connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuity such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility (device) or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

What is claimed is:

1. An electronic circuit to provide a high tube voltage for an X-ray tube, the electronic circuit comprising:
a first inverter unit configured to receive an input DC voltage and convert the input DC voltage into a first AC voltage based on a first manipulated variable;
a second inverter unit configured to receive the input DC voltage and convert the input DC voltage into a second AC voltage based on a second manipulated variable;
a further circuit part configured to generate the high tube voltage based on the first AC voltage and the second AC voltage, and make the high tube voltage available on an output side; and
a controller configured to determine a controlled variable, and change at least one of the first manipulated variable or the second manipulated variable based on the controlled variable, to control the controlled variable to a setpoint value, wherein
the controller is configured to determine the controlled variable based on at least one of
a first alternating current resulting from the first AC voltage and a second alternating current resulting from the second AC voltage, or
a first direct current resulting from the input DC voltage at the first inverter unit and a second direct current resulting from the input DC voltage at the second inverter unit.

2. The electronic circuit as claimed in claim 1, wherein the controlled variable depends on at least one of a difference between the first alternating current and the second alternating current or a difference between the first direct current and the second direct current.

3. The electronic circuit as claimed in claim 1, wherein
the controller is configured to determine a first characteristic value from the first alternating current and a second characteristic value from the second alternating current;
the controlled variable depends on the first characteristic value and the second characteristic value or the controlled variable depends on a difference between the first characteristic value and the second characteristic value;
the first characteristic value corresponds to a first effective value, a first rectified value or a first peak value; and
the second characteristic value corresponds to a second effective value, a second rectified value or a second peak value.

4. The electronic circuit as claimed in claim 3, wherein the controller is configured to
ascertain a largest characteristic value based on the first characteristic value and the second characteristic value,
change the first manipulated variable based on the controlled variable when the first characteristic value is less than the largest characteristic value, and
change the second manipulated variable based on the controlled variable when the second characteristic value is less than the largest characteristic value.

5. The electronic circuit as claimed in claim 1, wherein at least one of
the controller is configured to ascertain a controller manipulated variable based on the controlled variable and the setpoint value, and
the first manipulated variable depends on a difference between an initial value and the controller manipulated variable, or the second manipulated variable depends on a sum of the initial value and the controller manipulated variable.

6. The electronic circuit as claimed in claim 1, wherein the further circuit part includes a voltage transformer configured to
receive, on a primary side, a primary alternating voltage resulting from at least one of the first AC voltage or the second AC voltage, and
convert the primary alternating voltage into a secondary alternating voltage, wherein
the high tube voltage is based on the secondary alternating voltage.

7. The electronic circuit as claimed in claim 6, wherein the further circuit part includes a rectifier configured to convert the secondary alternating voltage into the high tube voltage.

8. The electronic circuit as claimed in claim 1, wherein
the further circuit part includes a first resonant circuit, the first resonant circuit being coupled to an output of the first inverter unit on an input side, and the first resonant circuit being coupled, on an output side, to an output of the further circuit part which is configured to provide the high tube voltage; and
the further circuit part includes a second resonant circuit, the second resonant circuit being coupled to an output of the second inverter unit on an input side, and the second resonant circuit being coupled, on an output side, to the output of the further circuit part.

9. The electronic circuit as claimed in claim 8, wherein an output of the first resonant circuit and an output of the second resonant circuit are coupled to one another.

10. The electronic circuit as claimed in claim 1, further comprising:
at least one further inverter unit, wherein
each further inverter unit, of the at least one further inverter unit, is configured to
receive the input DC voltage, and
convert the input DC voltage into a respective further AC voltage based on a respective further manipulated variable;
the further circuit part is configured to generate the high tube voltage based on the respective further AC voltages; and
the controller is configured to determine the controlled variable based on at least one of
the first alternating current, the second alternating current and a respective further alternating current resulting from the respective further AC voltages, or
the first direct current, the second direct current and a respective further direct current resulting from the input DC voltage at each further inverter unit.

11. An X-ray tube system comprising:
the electronic circuit as claimed in claim 1; and
an X-ray tube.

12. A medical imaging system including the X-ray tube system as claimed in claim 11.

13. A method for providing a high tube voltage for an X-ray tube, the method comprising:
converting an input DC voltage into a first AC voltage based on a first manipulated variable;
converting the input DC voltage into a second AC voltage based on a second manipulated variable;
generating the high tube voltage based on the first AC voltage and the second AC voltage;
determining a controlled variable based on at least one of
a first alternating current resulting from the first AC voltage and a second alternating current resulting from the second AC voltage, or
a first direct current resulting from the input DC voltage at a first inverter unit and a second direct current resulting from the input DC voltage at a second inverter unit; and
changing at least one of the first manipulated variable or the second manipulated variable based on the controlled variable, to control the controlled variable to a setpoint value.

14. The method as claimed in claim 13, wherein
the controlled variable depends on at least one of a difference between the first alternating current and the second alternating current or a difference between the first direct current and the second direct current, or
the controlled variable depends on a difference between a first characteristic value of the first alternating current and a second characteristic value of the second alternating current, wherein
the first characteristic value corresponds to a first effective value, a first rectified value or a first peak value, and
the second characteristic value corresponds to a second effective value, a second rectified value or a second peak value.

15. A method for operating an X-ray tube, the method comprising:
performing the method of claim 13; and
generating X-rays by the X-ray tube based on the high tube voltage.

16. The electronic circuit as claimed in claim 2, wherein at least one of
the controller is configured to ascertain a controller manipulated variable based on the controlled variable and the setpoint value, and
the first manipulated variable depends on a difference between an initial value and the controller manipulated variable, or the second manipulated variable depends on a sum of the initial value and the controller manipulated variable.

17. The electronic circuit as claimed in claim 3, wherein at least one of
the controller is configured to ascertain a controller manipulated variable based on the controlled variable and the setpoint value, and
the first manipulated variable depends on a difference between an initial value and the controller manipulated variable, or the second manipulated variable depends on a sum of the initial value and the controller manipulated variable.

18. The electronic circuit as claimed in claim 3, wherein the further circuit part includes a voltage transformer configured to
receive, on a primary side, a primary alternating voltage resulting from at least one of the first AC voltage or the second AC voltage, and
convert the primary alternating voltage into a secondary alternating voltage, wherein
the high tube voltage is based on the secondary alternating voltage.

19. The electronic circuit as claimed in claim 3, wherein
the further circuit part includes a first resonant circuit, the first resonant circuit being coupled to an output of the first inverter unit on an input side, and the first resonant circuit being coupled, on an output side, to an output of the further circuit part which is configured to provide the high tube voltage; and
the further circuit part includes a second resonant circuit, the second resonant circuit being coupled to an output of the second inverter unit on an input side, and the second resonant circuit being coupled, on an output side, to the output of the further circuit part.

20. The electronic circuit as claimed in claim 3, further comprising:
at least one further inverter unit, wherein
each further inverter unit, of the at least one further inverter unit, is configured to
receive the input DC voltage, and
convert the input DC voltage into a respective further AC voltage based on a respective further manipulated variable;
the further circuit part is configured to generate the high tube voltage based on the respective further AC voltages; and
the controller is configured to determine the controlled variable based on at least one of
the first alternating current, the second alternating current and a respective further alternating current resulting from the respective further AC voltages, or
the first direct current, the second direct current and a respective further direct current resulting from the input DC voltage at each further inverter unit.
